(19) United States
(12) Patent Application Publication
(10) Pub. No.: US 2016/0212198 A1
(43) Pub. Date: Jul. 21, 2016

(54) SYSTEM OF HOST CACHES MANAGED IN A UNIFIED MANNER

(71) Applicant: NetApp, Inc., Sunnyvale, CA (US)

(72) Inventors: Somasundaram Krishnasamy, Austin, TX (US); Brian McKean, Boulder, CO (US); Yanling Qi, Austin, TX (US)

(21) Appl. No.: 14/599,251

(22) Filed: Jan. 16, 2015

(51) Int. Cl. H04L 29/08

(52) U.S. Cl. CPC H04L 67/10

(57) ABSTRACT

A method and system for host caches managed in a unified manner are described. In an example, a server in a clustered environment designates cache ownership for a cluster application to the cache on one of the hosts. While the application is running on this host, the server monitors data writes made by the application. Upon detecting that the application is running on a different host in the clustered environment, the server can transfer cache ownership to the new host and selectively invalidate cache blocks in the cache of the new host based on the data writes that were previously monitored.

### TECHNICAL FIELD

Examples described herein relate to caching, and more specifically, to a system and method for host caches managed in a unified manner.

### BACKGROUND

Data storage technology over the years has evolved from a direct attached storage model (DAS) to using remote computer storage models, such as Network Attached Storage (NAS) and Storage Area Network (SAN). With the direct storage model, the storage is directly attached to the workstations and applications servers, but this creates numerous difficulties with administration, backup, compliance, and maintenance of the directly stored data. These difficulties are alleviated at least in part by separating the application server/workstations form the storage medium, for example, using a computer storage network.

A typical NAS system includes a number of networked servers (e.g., nodes) for storing client data and/or other resources. The servers may be accessed by client devices (e.g., personal computing devices, workstations, and/or application servers) via a network such as, for example, the Internet. Specifically, each client device may issue data access requests (e.g., corresponding to read and/or write operations) to one or more of the servers through a network of routers and/or switches. Typically, a client device uses an IP-based network protocol, such as Common Internet File System (CIFS) and/or Network File System (NFS), to read from and/or write to the servers in a NAS system.

Conventional NAS servers include a number of data storage hardware components (e.g., hard disk drives, processors for controlling access to the disk drives, I/O controllers, and high speed cache memory) as well as an operating system and other software that provides data storage and access functions. Frequently-accessed (“hot”) application data may be stored on the high speed cache memory of a server node to facilitate faster access to such data. The process of determining which application data is hot and copying that data from a primary storage array into cache memory is called a cache “warm-up” process. However, when a particular node is rendered unusable and/or is no longer able to service data access requests, it may pass on its data management responsibilities to another node in a node cluster (referred to as “node failover”). In conventional implementations, the new node subsequently warms up its cache starting from empty even when it's possible that the new node has some up-to-date cached application data that remains usable.

### BRIEF DESCRIPTION OF THE DRAWINGS

FIG. 1 illustrates an example system for host caches managed in a unified manner, in accordance with some aspects.

FIG. 2 illustrates an example controller for managing caches on hosts in a unified manner, in accordance with some aspects.

FIG. 3A illustrates an example flow diagram for managing caches on hosts in a unified manner, in accordance with some aspects.

FIG. 3B illustrates an example flow diagram for passing cache ownership and selectively invalidating cache blocks, in accordance with some aspects.

FIG. 4 illustrates an example flow chart for managing caches on hosts in a unified manner, in accordance with some aspects.

FIG. 5 is a block diagram that illustrates a computer system upon which aspects described herein may be implemented.

### DETAILED DESCRIPTION

Examples described herein include a storage system to manage a number of memory caches on hosts in a clustered environment. More specifically, controllers on the storage system can direct the hosts to cache data for applications, invalidate stale blocks in the caches, and instruct caches to discard their contents for specified LUNs (logical unit numbers) based on monitored data reads and writes made by the applications on other hosts. In this manner, cache consistency can be maintained without having to discard an entire cache when an application is transferred from one host to another.

In a high availability cluster environment, a storage server shares access to its volumes with multiple server nodes, or hosts. When an application running on the primary host fails, the application is started on a backup host on the cluster (failover). When the primary host becomes operational again, the application can be moved back to the original host on which it was running (failback). Application migration between servers can also occur as a result of administrator actions or through an automated process performed by an agent external to the storage server. The server can use host-based flash cache solutions to cache the data locally in order to provide low latency and high bandwidth I/O performance to applications. When the application migrates between cluster nodes, frequently accessed data can be made available in the host cache so that the applications can find the data on the low latency cache device, which provides better performance than reading data from the volumes on the storage server.

In an example, a server in a clustered environment designates cache ownership for a cluster application to the cache on one of the hosts. While the application is running on this host, the server monitors data writes made by the application. Upon detecting that the application is running on a different host in the clustered environment, the server can transfer cache ownership to the new host and selectively invalidate cache blocks in the cache of the new host based on the data writes that were previously monitored.

In some aspects, the server designates and transfers cache ownership only once a threshold number of read/write operations for the application is received from the host to be given cache ownership.

In one aspect, the server starts the application on a second host when it determines that the first host running the application is down. In another aspect, the first host can still be operational, but the server starts the application on the second host for performance reasons. In further aspects, an agent external to the storage server starts the application on the second host, and the storage server detects the application running on the host second through the monitored I/O operations.

According to some examples, when the server designates or transfers cache ownership, the cache of the owning host is set to write-through mode and any previously owning cache is set to pass-through mode.

In some aspects, detecting that the application is running on the second host in the clustered environment also includes detecting that the application is not running on the first host.

In further aspects, selectively invalidating cache blocks in the second cache includes discarding all data in the second cache upon determining that the second host did not have the cache ownership prior to the first host having the cache ownership.

In some examples, the server in the clustered environment is a storage array.

By managing host caches in a unified manner from a storage server, cache consistency can be maintained for an application without having to discard all of a previous host's cached data for the application when it is migrated back to the previous host. This allows a more seamless transition between clustered host failover and failback states with higher performance and less overhead. Performing cache management on the storage server also ensures data integrity by coordinating the access of volumes between cluster nodes. The server can obtain the advantage of host cache performance without requiring changes to cluster management software for host cache management.

The term “high-availability clusters” (also known as HA clusters or failover clusters) refers to groups of host computers that support server applications that can be reliably utilized with a minimum of down-time. They operate by harnessing redundant computers in groups or clusters that provide continued service when system components fail. Without clustering, if a server running a particular application crashes, the application may be unavailable until the crashed server is fixed. HA clustering remedies this situation by detecting hardware/software faults and immediately restarting the application on another system without requiring administrative intervention, a process known as failover. When the original host system is once again available, the application can be restarted on the original host system in a process known as failback.

In computer storage, a logical unit number, or LUN, is a number used to identify a logical unit, which is a device addressed by the SCSI protocol or Storage Area Network (SAN) protocols which encapsulate SCSI, such as Fibre Channel or iSCSI. A LUN may be used with any device which supports read/write operations, such as a tape drive, but is most often used to refer to a logical disk as created on a SAN.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

### System Overview

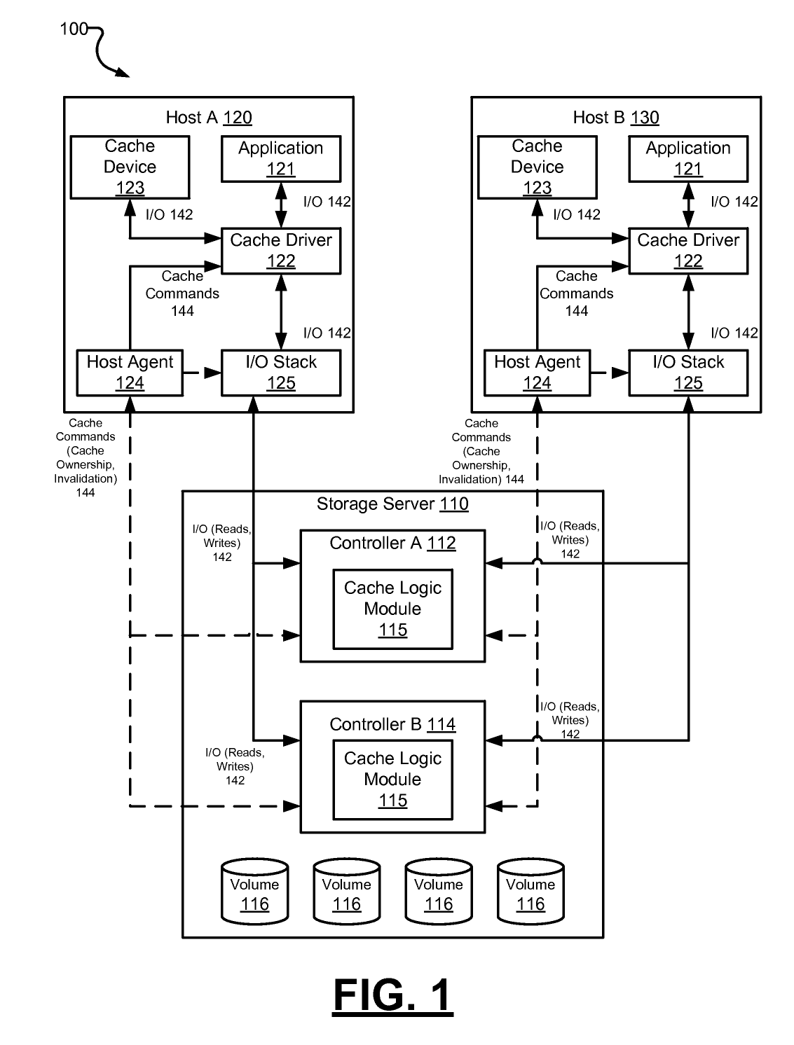

FIG. 1 illustrates an example clustered system 100 for host caches managed in a unified manner, in accordance with some aspects. The clustered system 100 includes a storage server 110 and a pair of hosts: Host A 120 and Host B 130. Although FIG. 1 depicts two hosts, more than two can be employed in the clustered system 100 to similar effect. Storage server 110 and hosts 120, 130 are shown with specific components but can contain others that have been omitted for simplicity.

Storage server 110, also known as a storage array, comprises controller A 112, controller B 114, and a number of volumes 116 spread across physical disks such as hard disk drives, solid state drives, tape devices, and other physical media. Although storage system 110 is described with two controllers, storage server 110 can contain one controller or three or more controllers in other examples. Each of the controllers 112, 114 include a cache logic module 115 to determine cache commands 144 to send to the hosts 120, 130. These cache commands 144 include commands such as giving the cache on one host ownership, changing the cache mode on the host, or invalidating certain cached blocks on the host. In some aspects, cache commands 144 are executed on a per-LUN basis. For example, a command to change the cache mode on the host specifies a LUN, and only that LUN's mode is changed.

Each of the hosts 120, 130 in the clustered system 100 are capable of running clustered applications 121. In one example, application 121 runs on either Host A 120 or Host B 130, but not both simultaneously. The application 121 communicates with clients and other servers in order to provide services. When those clients and other servers request data or perform actions that require data to be written, application 121 sends input/output (I/O, e.g., data read and write operations) requests 142 to a cache driver 122. Depending on the current mode of the cache driver 122, the I/O request 142 can be passed through to the I/O stack 125 or sent to the cache device 123 and the I/O stack 125.

At host startup and when not the cache owner for a LUN used by application 121, cache logic module 115 places a host's cache driver 122 in pass-through, write-around mode. In pass-through, write-around mode, if the cache driver 122 determines that a write operation is a cache miss, it sends the write operation to the I/O stack 125. If the write operation is a cache hit, that is, a matching block is found in the cache device 123, the matching block is invalidated before the write operation is sent to the I/O stack 125. In some examples, cache device 123 is a flash memory device capable of retaining data after a reboot or loss of power in Host A 120. Cache device 123 transparently stores data so that future requests for that data can be served faster.

When cache logic module 115 designates a Host As cache owner for application 121, the cache driver 122 is placed in write-through mode, wherein data writes are sent to be written in both the cache device 123 and I/O stack 125 to be written to the storage server 110. In either mode, I/O stack 125 transmits the I/O requests 142 to controllers 112, 114 on the storage server 110 to be written to volumes 116.

Host agent 124 handles communications between the cache driver 122, I/O stack 125, and the controllers 112, 114 on storage server 110. In some examples, the communication channel can be out-of-band, such as through a network connection using TCP/IP. In other examples, the communication channel can be in-band using the storage I/O path. Host agent 124 exchanges a number of different messages and cache commands 144 between the hosts 120, 130 and the storage server 110. First, commands to take cache LUN ownership or give it up, such as when the application 121 is started on the host or restarted on another host. Second, invalidate specific blocks in the cache device 123 or invalidate a list of extents, which identify contiguous areas of storage in a computer file system reserved for a file. These scenarios can occur when a host 120, 130 has data cached for a LUN but is not the current owner of that LUN. Third, discard all cache blocks in the cache device 123 for a LUN, which can be performed when a host 120, 130 is given ownership of the LUN but was not the previous cache owner of the LUN. Fourth, prefetch a list of extents to store in the cache device 123, and fifth, save cache blocks' hotness information to store and retrieve later from the storage server 110.

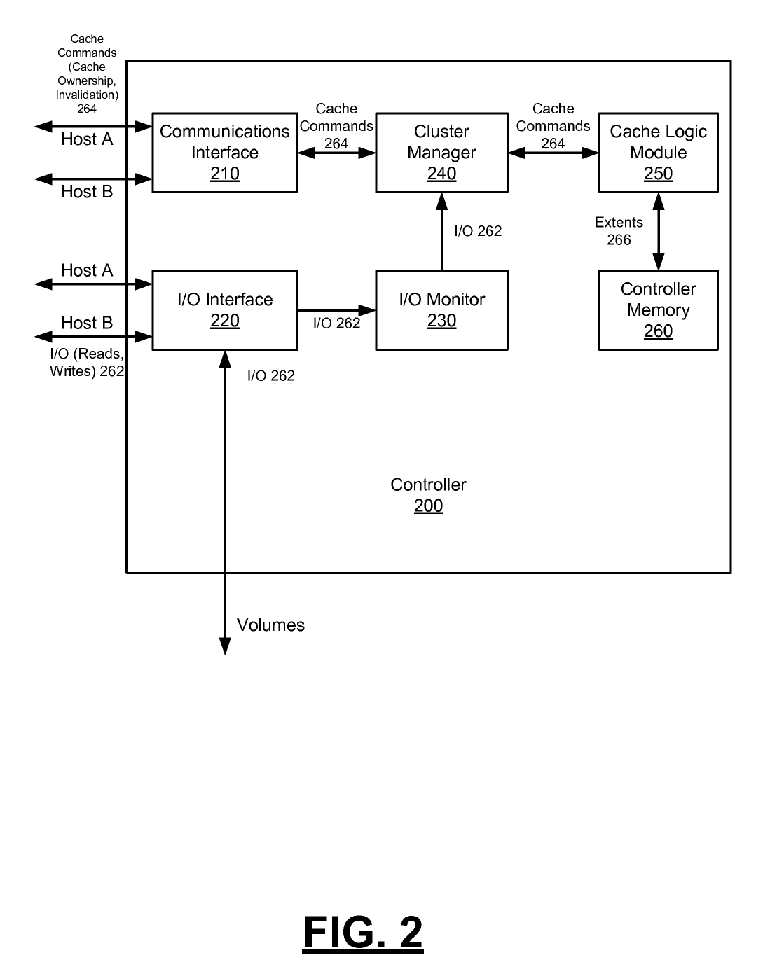

FIG. 2 illustrates an example controller 200 for managing caches on hosts in a unified manner, in accordance with some aspects. Controller 200 may be, for example, one of controller A 112 or controller B 114 depicted as part of storage server 110 in FIG. 1.

Communications interface 210 handles all communications between the cluster manager 240 and the host agents on the hosts. Communications include cache commands 264 described above, such as cache ownership messages and cache invalidation commands. I/O interface 220 receives read and write I/O requests 262 from the I/O stack on the hosts, which are passed to the correct LUN on the volumes attached to the storage array. For data read requests, the I/O interface 220 receives the requested data back from the volumes and passes them on to the requesting host. In addition, I/O requests 262 are read by an I/O monitor 230 in order to determine whether to designate or transfer cache ownership for a LUN. For example, once I/O monitor 230 receives a number of I/O requests 262 beyond a predetermined threshold from a given host for a specific LUN, it signals cluster manager 240 to designate that Host As the cache owner for the LUN and remove any cache ownership from any other host that is currently the cache owner.

In some aspects, cluster manager 240 executes cluster software to issue cache commands 264, manage hosts, and manage volumes on the storage server. Cluster manager 240 can monitor the status of the hosts, such as whether they are up or down, along with performance details that are used in determining whether to migrate an application from one host to another. For example, if one host becomes unreachable to the controller 200, cluster manager 240 can start the application running on a second host as backup. In other aspects, cluster software to manage hosts, such as migrating applications between hosts, runs on an agent or agents external to controller 200.

Cache logic module 250 operates to determine cache ownership for the hosts, including designating initial ownership, changing ownership to another host, and setting cache modes on the hosts such as write-through and pass-through. These are examples of cache commands 264 generated by cache logic module 250 and ultimately sent to the hosts in the clustered environment. In addition, cache logic module 250 can store extents 266 in controller memory 260, which each identify a logical block address (LBA) and length of data written to the volumes by one of the hosts. Logical block addressing is a common scheme used for specifying the location of blocks of data stored on computer storage devices, such as the volumes on the storage server. Through the use of a list of extents, stale data stored in one of the host caches can be identified and invalidated with a minimal use of network traffic and processor usage.

### Methodology

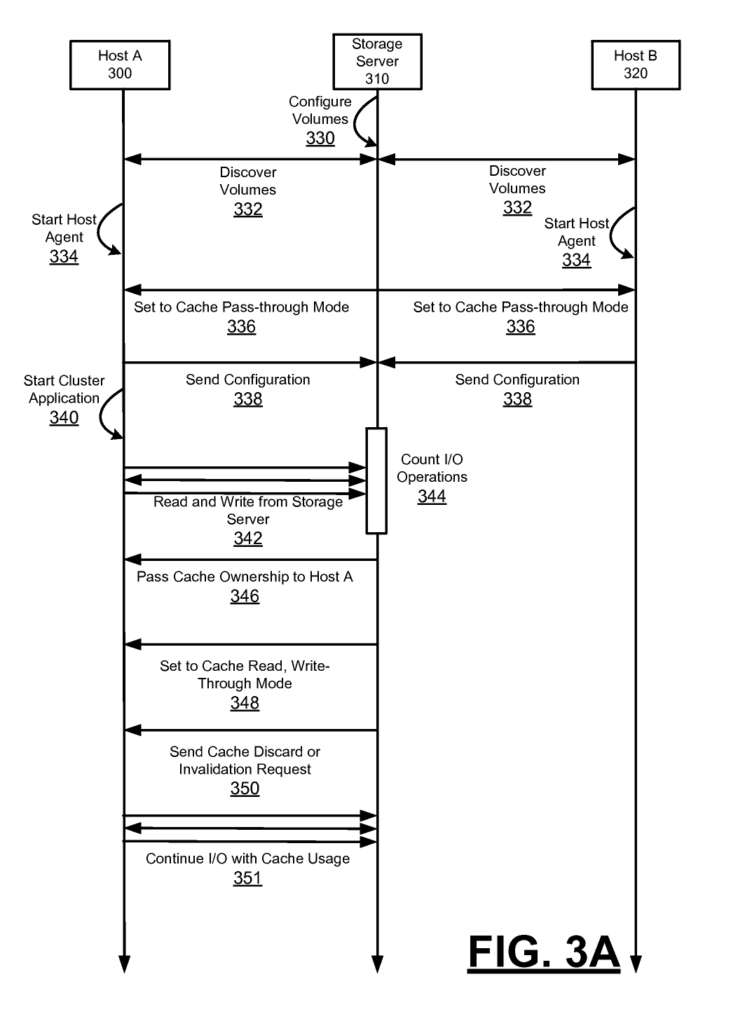

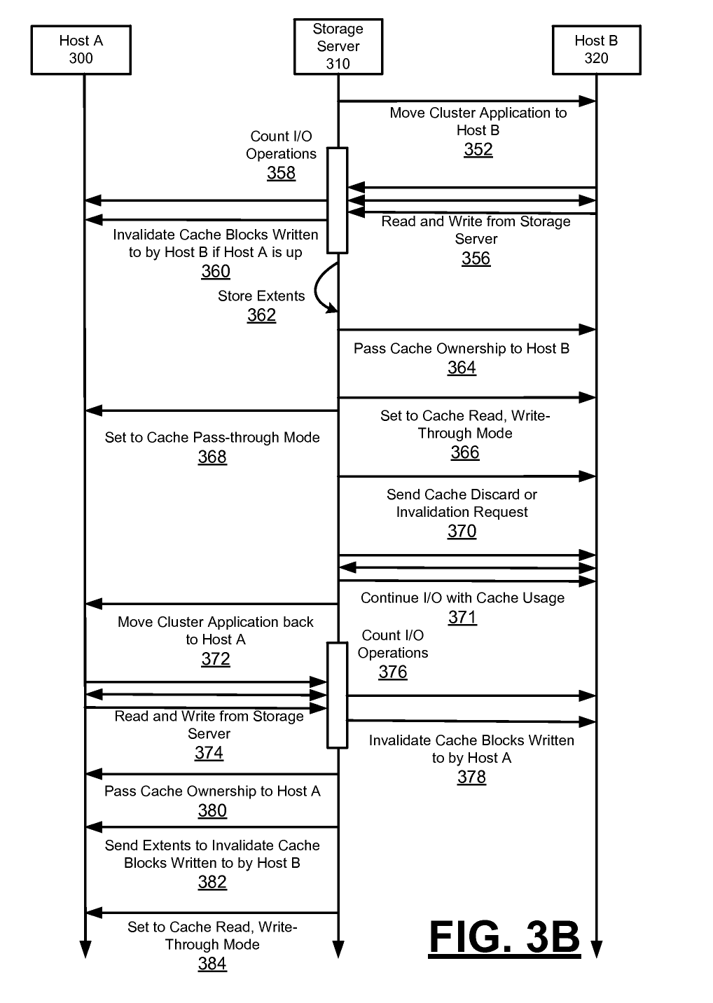

FIG. 3A illustrates an example flow diagram for managing caches on hosts in a unified manner, in accordance with some aspects. FIG. 3B illustrates an example flow diagram for passing cache ownership and selectively invalidating cache blocks, in accordance with some aspects.

While operations detailed in the flow diagrams are described below as being performed by specific components, modules or systems of the clustered system 100, it will be appreciated that these operations need not necessarily be performed by the specific components identified, and could be performed by a variety of components and modules, potentially distributed over a number of machines. Accordingly, references may be made to elements of clustered system 100 for the purpose of illustrating suitable components or elements for performing a step or sub step being described. Alternatively, at least certain ones of the variety of components and modules described in clustered system 100 can be arranged within a single hardware, software, or firmware component. It will also be appreciated that some of the steps of this method may be performed in parallel or in a different order than illustrated.

FIGS. 3A and 3B illustrate operations executed by Host A 300, storage server 310, and Host B 320, which may be, for example, servers depicted as part of clustered system 100 in FIG. 1. With reference to an example of FIG. 3A, controllers in storage server 310 configure the storage array volumes (330). Configuration can include details such as on which physical disks the volumes are provided, file systems, LUN assignments, provisioning, and optimization features like compression and deduplication. Once the volumes have been properly configured, Host A 300 and Host B 320 can discover the volumes on the storage array and save the configuration details of the volumes for use by clustered applications running on the hosts (332).

In some aspects, a host agent starts on each host to manage communications between the hosts and the storage server 310 (334). The host agents are specifically configured to receive cache commands such as ownership changes and invalidation requests from controllers on the storage server 310 and send those commands to the cache driver on the host, among other duties.

Upon startup and otherwise when not the cache owner for a given LUN, the cache driver sets the cache for that LUN on each host to pass-through, write-around mode (336). In this mode, all write I/O cache hits are invalidated in the host cache before the write I/O is sent to the storage server 310 to be written to a volume. Host agents also gather and send all information that the storage server 310 needs to properly manage host caches (338). Host agents then monitor for further communications from the storage server 310.

During normal operation of the clustered system, Host A 300 can start a cluster application (340). This can be done in response to a client request or an automated process. Cluster software can determine which of the hosts 300, 320 runs the cluster application based on current loads on the hosts or other performance factors. In some examples, Host B 320 may be a backup for Host A 300 and only used in the event of failure in Host A 300. In one example, the cluster application runs on both Host A 300 and Host B 320 simultaneously. In this example, both host caches remain in pass-through mode and are therefore not utilized because of the possibility for inconsistency between cached data at the hosts.

With the cluster application started, whenever it needs to read or write data, it sends I/O requests to the host cache driver. Since the cache driver is in pass-through mode, all I/O requests bypass the host cache and are sent to be fulfilled by the storage server 310 (342). Each time the storage server 310 receives one of these I/O requests for a LUN, it increments a counter associated with the LUN in order to track which of the hosts 300, 320 is using that LUN (344). After the counter passes a predetermined threshold of I/O requests, storage server 310 gives cache LUN ownership to the host sending the I/O requests. This threshold can be set to any number with various trade-offs. For example, a low threshold can allow a host to utilize its cache earlier to improve I/O performance, but this low threshold can also cause an undesired change in ownership in situations where the previously owning host was only down for a moment. A high threshold can prevent undesired ownership changes, but also delays the time it takes to begin using the host cache on a new Host After application migration.

In the example of FIG. 3A, storage server 310 receives the threshold number of I/O operations from Host A 300 and passes cache ownership to Host A 300 (346). The Host agent on Host A 300 instructs its cache driver to begin caching, that is, reading cached data on cache hits for reads and writing data to the cache on writes. The host cache for Host A 300 is placed into write-through mode (348). In this mode, data writes are sent to the local cache device to be written and also sent to the storage server 310 to be written onto a volume.

In addition, storage server 310 determines whether Host A 300 is allowed to use previously cached data, and if so, which parts of the cached data. If Host A 300 was not the last cache owner for the LUN, storage server 310 signals Host A 300 to discard its existing cached data for that LUN (350). In some examples, storage server 310 can send fast warm-up data to prefetch blocks, such as described in U.S. patent application Ser. No. 14/302,863, FAST WARM-UP OF HOST FLASH CACHE AFTER NODE FAILOVER, hereby incorporated by reference in its entirety.

In some examples, storage server 310 sends invalidation requests to Host A 300 as data writes are received from other hosts and written to volumes; however, it is possible that Host A 300 is unreachable during this time. Therefore, when Host A 300 was the last cache owner for the LUN, instead of signaling Host A 300 to discard its cached data, storage server 310 instead transmits a list of extents to be invalidated in Host A′s cache. These extents represent logical block addresses and lengths of data writes to the LUN that occurred while Host A 300 did not have cache LUN ownership. Through this process, the cache driver discards stale data in the cache on Host A 300 while up-to-date cached data remains available for reading by the application.

Since Host A 300 has cache ownership of the LUN, read requests from the application to the LUN are first checked in the cache device of Host A 300 (351). If there is a cache hit, the cache driver returns the cached data, eliminating the need to contact the storage server and thereby increasing performance. Write requests are written both into the cache of Host A 300 and the volumes residing on storage server 310.

Turning now to FIG. 3B, storage server 310 moves the cluster application to Host B 320 (352). This can occur when Host A 300 goes down or as a result of an automated or manual process. For example, storage server 310 may migrate the application to Host B 320 if Host A 300 is overloaded. Alternatively, an administrator can manually choose to migrate the application. In other aspects, an agent external to storage server 310, such as cluster software running on a cluster management server, moves the cluster application instead.

Once migrated, the application running on Host B 320 begins sending I/O operations to storage server 310 (356). Storage server 310 receives and counts these I/O operations as the requested data is stored or retrieved from the volumes (358). Based on this pattern of I/O operations, storage server 310 detects that the cluster application is now running on Host B 320. In examples where Host A 300 is still operational and responsive, storage server 310 can transmit to Host A 300 extents for the write requests received from Host B 320 associated with the application. The cache driver on Host A 300 can then check its cache device for blocks matching the write requests, and if found, invalidate the blocks in the cache (360). Storage server 310 can also store the extents in controller memory so that they can be sent to Host A 300 at a later time, such as when Host A 300 is up (362). This can be done in cases where Host A 300 is down when the write requests are made by Host B 320.

After receiving a number of I/O operations for a LUN exceeding a predetermined threshold, storage server 310 passes cache ownership for the LUN to Host B 320 (364). Similar to the process described with respect to FIG. 3A regarding Host A 300, storage server 310 sets the cache driver of Host B 320 to cache read, write-through mode so that Host B 320 can utilize its cache device for the LUN. If Host A 300 is up, storage server 310 also sets the cache driver of Host A 300 back to pass-through mode (368). Since Host A 300 is no longer the cache owner for the LUN, it should not read potentially stale data from its cache or waste resources storing more data in its cache for the LUN while it is not the owner.

In addition, storage server 310 determines whether Host B 320 is allowed to use previously cached data, and if so, which parts of the cached data. If Host B 320 was not the last cache owner for the LUN, storage server 310 signals Host B 320 to discard its existing cached data for that LUN (370). In some examples, storage server 310 can send fast warm-up data to prefetch blocks.

Since Host B 320 has cache ownership of the LUN, read requests from the application to the LUN are first checked in the cache device of Host B 320 (371). If there is a cache hit, the cache driver returns the cached data, eliminating the need to contact the storage server and thereby increasing performance. Write requests are written both into the cache of Host B 320 and the volumes residing on storage server 310.

Once Host A 300 is back up, cluster manager on the storage server 310 can migrate the application back to Host A 300 (372). Alternatively, if Host A 300 remained operational while the application was migrated to Host B 320, the application can be migrated back for performance or if Host B 320 goes down. This can be done as an automated process performed by an agent external to the storage server 310 or manually triggered by an administrator.

Once migrated back, the application running on Host A 300 resumes sending I/O operations to storage server 310 (374). Storage server 310 receives and counts these I/O operations as the requested data is stored or retrieved from the volumes (376). In examples where Host B 320 is still operational and responsive, storage server 310 can transmit to Host B 320 extents for the write requests received from Host A 300 associated with the application. The cache driver on Host B 320 can then check its cache device for blocks matching the write requests, and if found, invalidate the blocks in the cache (378). Storage server 310 can also store the extents in controller memory so that they can be sent to Host B 320 at a later time, such as when Host A 320 is up. This can be done in cases where Host B 320 is down when the write requests are made by Host A 300.

After receiving a number of I/O operations for a LUN exceeding a predetermined threshold, storage server 310 passes cache ownership for the LUN to Host A 300 (380). Storage server 310 sets the cache driver of Host A 300 to cache read, write-through mode so that Host A 300 can utilize its cache device for the LUN (382). In addition, storage server 310 determines whether Host A 300 is allowed to use previously cached data, and if so, which parts of the cached data. In the example illustrated with FIG. 3B, Host A 300 was the last cache owner for the LUN. Therefore, storage server 310 sends a list of extents to invalidate cache blocks that were written to by Host B 320 and directs Host A 300 to use its previously cached data (384).

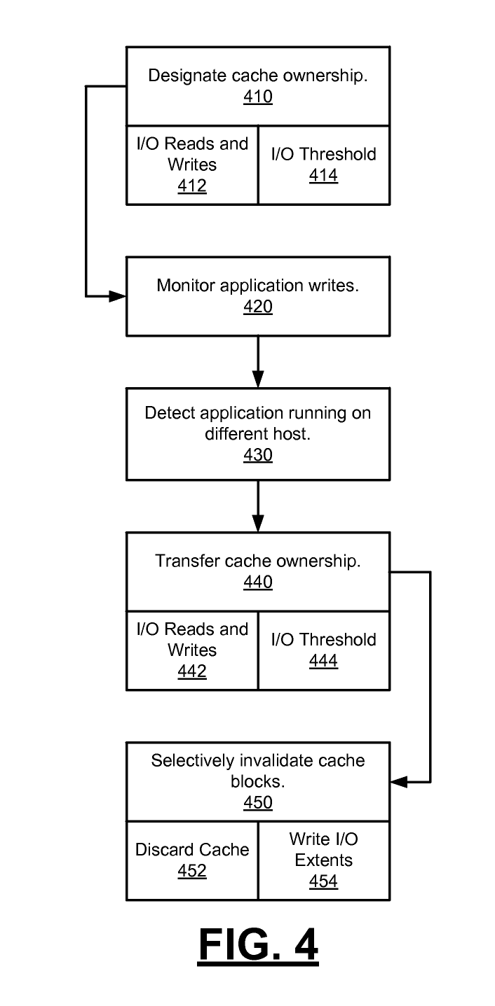

FIG. 4 illustrates an example flow chart for managing caches on hosts in a unified manner, in accordance with some aspects.

A server in a clustered environment designates cache ownership for a cluster application to the cache on one of the hosts (410). In some examples, this ownership may extend to a particular LUN that the application accesses. The server can count I/O reads and writes (412) up to a threshold value (414) before determining whether to designate cache ownership.

While the application is running on this host, the server monitors data writes made by the application (420). The server can detect that the application is running on a different host in the clustered environment (430), which can occur as a result of an automated process on the server or manual intervention, such as an administrator command.

Similar to the process of designating cache ownership, the server can transfer cache ownership to the new host (440), for example, after determining that a count of I/O reads and writes (442) exceeds a predetermined I/O threshold (444). Whether before or after, the server can selectively invalidate cache blocks in the cache of the new host based on the data writes that were previously monitored (450). In some examples, the entire cache of data for the LUN stored in the new host is discarded (452), and in other examples, only those blocks identified by a list of I/O extents received from the server are invalidated, leaving the rest of the cached blocks for the LUN ready to be read (454).

### Computer System

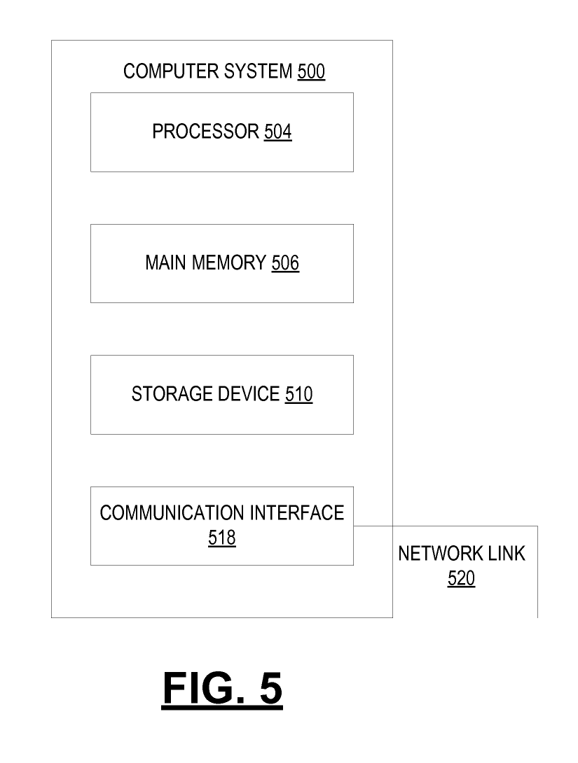

FIG. 5 is a block diagram that illustrates a computer system upon which aspects described herein may be implemented. For example, in the context of FIG. 1, system 100 may be implemented using one or more servers such as described by FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an embodiment, can be combined with other individually described features, or parts of other aspects. Thus, absence of describing combinations should not preclude the inventor(s) from claiming rights to such combinations.

What is claimed is:

1. A system for managing a plurality of caches, the system comprising:
a plurality of hosts in a clustered environment, each host coupled to a cache of the plurality of caches; and
a server to (1) designate cache ownership to a first cache of the plurality of caches on a first host of the plurality of hosts for an application running on the first host, (2) monitor data writes made by the application while the application is running on the first host, (3) detect that the application is running on a second host in the clustered environment, (4) transfer the cache ownership to a second cache on the second host, and (5) selectively invalidate cache blocks in the second cache based on the monitored data writes.

2. The system of claim 1, wherein the cache ownership is designated or transferred based on a received number of read and write operations exceeding a predetermined threshold.

3. The system of claim 1, further comprising:
starting the application on the second host upon a determination that the first host is down or for performance reasons.

4. The system of claim 3, wherein the application is started on the second host by the server or an agent external to the server.

5. The system of claim 1, wherein the first cache is set to pass-through mode and the second cache is set to write-through mode upon transferring the cache ownership to the second cache on the second host.

6. The system of claim 1, wherein detecting that the application is running on the second Host Also includes detecting that the application is not running on the first host.

7. The system of claim 1, wherein selectively invalidating cache blocks in the second cache includes discarding all data in the second cache associated with the application upon determining that the second host did not have the cache ownership prior to the first host having the cache ownership.

8. The system of claim 1, where in the server is a storage array.

9. A method of managing a plurality of caches, the method being implemented by one or more processors and comprising:
designating, at a server in a clustered environment, cache ownership to a first cache on a first host for an application running on the first host;
monitoring data writes made by the application while the application is running on the first host;
detecting that the application is running on a second host in the clustered environment;
transferring the cache ownership to a second cache on the second host; and
selectively invalidating cache blocks in the second cache based on the monitored data writes.

10. The method of claim 9, wherein the cache ownership is designated or transferred based on a received number of read and write operations exceeding a predetermined threshold.

11. The method of claim 9, further comprising:
starting the application on the second host upon a determination that the first host is down or for performance reasons.

12. The method of claim 11, wherein the application is started on the second host by the server or an agent external to the server.

13. The method of claim 9, wherein the first cache is set to pass-through mode and the second cache is set to write-through mode upon transferring the cache ownership to the second cache on the second host.

14. The method of claim 9, wherein detecting that the application is running on the second Host Also includes detecting that the application is not running on the first host.

15. The method of claim 9, wherein selectively invalidating cache blocks in the second cache includes discarding all data in the second cache associated with the application upon determining that the second host did not have the cache ownership prior to the first host having the cache ownership.

16. The method of claim 9, where in the server is a storage array.

17. A non-transitory computer-readable medium that stores instructions, executable by one or more processors, to cause the one or more processors to perform operations that comprise:
designating, at a server in a clustered environment, cache ownership to a first cache on a first host for an application running on the first host;
monitoring data writes made by the application while the application is running on the first host;
detecting that the application is running on a second host in the clustered environment;
transferring the cache ownership to a second cache on the second host; and
selectively invalidating cache blocks in the second cache based on the monitored data writes.

18. The non-transitory computer-readable medium of claim 17, wherein the cache ownership is designated or transferred based on a received number of read and write operations exceeding a predetermined threshold.

19. The non-transitory computer-readable medium of claim 17, further comprising instructions for:
starting the application on the second host upon a determination that the first host is down or for performance reasons.

20. The non-transitory computer-readable medium of claim 19, wherein the application is started on the second host by the server or an agent external to the server.
